(19) United States
(12) Patent Application Publication
(10) Pub. No.: US 2005/0027731 A1
(43) Pub. Date: Feb. 3, 2005

(54) Compression dictionaries

(76) Inventor: Daniel Revel, Portland, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/629,956

(22) Filed: Jul. 30, 2003

(51) Int. Cl. G06F 7/00

(52) U.S. Cl. 707/101

(57) ABSTRACT

A system and method of responding to a request for information and requesting information including caching a compression dictionary, sending and receiving a request for information, compressing the request and requested information using the compression dictionary, decompressing the request and requested information, and sending the compressed request and compressed information. Further, compressing and decompressing information to and from an object model document such as DOM. A system and method for creating a compression dictionary, wherein the compression dictionary comprises document segments such as XML tags and character codes that represent the document segments when compressed.

### FIELD OF THE INVENTION

The present invention relates to message compression; more specifically, message compression and sharing according to a derived compression dictionary.

### BACKGROUND OF THE INVENTION

With the increase in Internet use over recent years, Internet and network bandwidth capabilities are being increasingly taxed. Within this increased usage, network users are requesting and receiving more and more. Further, businesses are conducting more and more business over the Internet and other large scale networks. This growth in use has come at the cost of communication and processing efficiency which has caused increased network latency.

One method of solving the resultant increase in network latency has been to compress messages between nodes on networks. For example, gzip (Lempel-Ziv) compression, described in IETF RFC 1952, is one such method. HTTP 1.1 defined in IETF RFC 2616 defines content encodings based on gzip compression. Many web browsers are capable of accepting compressed HTTP content, some web servers are capable of delivering either statically or dynamically compressed HTTP content.

However, compressed messages, such as those compressed using gzip compression, include a compression dictionary within the message stream that is necessary for message decompression. This included compression dictionary adds to the size of the message and reduces the effectiveness in reducing network traffic, the speed of message transport across networks, and increases the use of processor bandwidth.

### BRIEF DESCRIPTION OF THE DRAWINGS

The following drawings are various representations of embodiments of the invention. Other embodiments are within the scope of the claims herein.

FIG. 1 shows a schematic diagram of a system according to an embodiment of the invention.

FIG. 2 shows a flow diagram of a method according to an embodiment of the invention.

FIG. 3 shows a flow diagram of a method according to an embodiment of the invention.

FIG. 4 shows a flow diagram of a method according to an embodiment of the invention.

FIG. 5A shows a flow diagram of a method according to an embodiment of the invention.

FIG. 5B shows a flow diagram of a method according to an embodiment of the invention.

FIG. 5C shows a flow diagram of a method according to an embodiment of the invention.

FIG. 6 shows a flow diagram of a method according to an embodiment of the invention.

FIG. 7 shows a flow diagram of a method according to an embodiment of the invention.

FIG. 8 shows a flow diagram of a method according to an embodiment of the invention.

FIG. 9 shows a flow diagram of a method according to an embodiment of the invention.

FIG. 10A shows an exemplary Simple Object Access Protocol (SOAP) request message according to an embodiment of the invention.

FIG. 10B shows an embodiment of a compression dictionary according to an embodiment of the invention.

FIG. 10C shows a compressed message according to an embodiment of the invention.

FIG. 11 shows a block diagram of a computer system according to an embodiment of the invention.

### DETAILED DESCRIPTION OF THE INVENTION

In the following description and the drawings illustrate specific embodiments of the invention sufficiently to enable those skilled in the art to practice it. Other embodiments may incorporate structural, logical, electrical, process, and other changes. Examples merely typify possible variations. Individual components and functions are optional unless explicitly required, and the sequence of operations may vary. Portions and features of some embodiments may be included in or substituted for those of others. The scope of the invention encompasses the full ambit of the claims and all available equivalents. The following description is, therefore, not to be taken in a limited sense, and the scope of the present invention is defined by the appended claims.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

The functions described herein are implemented in software in one embodiment, where the software comprises computer executable instructions stored on computer readable media such as memory or other type of storage devices. The term “computer readable media” is also used to represent carrier waves on which the software is transmitted. Further, such functions correspond to modules, which are software, hardware, firmware of any combination thereof. Multiple functions are performed in one or more modules as desired, and the embodiments described are merely examples.

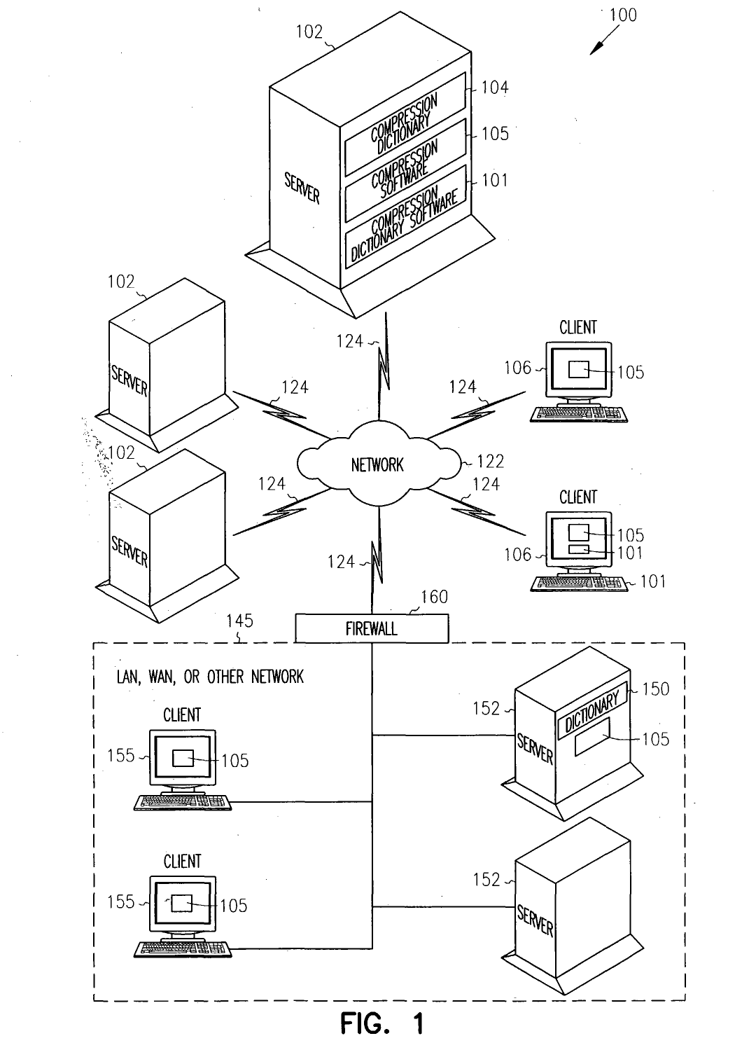

FIG. 1 shows an exemplary embodiment of a communication system 100 that provides for transfer of data between multiple devices. This embodiment of system 100 comprises multiple servers 102, client work stations 106, the servers 102 and client workstations 106 operatively connected via communication lines 124 to a network 122. In one embodiment, network 122 comprises the Internet, or other type of public or private network that allows data transfer. Communication lines 124 may be any type of communication medium, such as telephone lines, cable, optical fiber, wireless, or any other communication medium that allows data transfer between devices coupled to the network.

One or more of the servers 102 hold a compression dictionary 104, which is available for download to the other servers 102 and workstation clients 106 connected 124 to the network 122. Compression dictionary 104 is used by operable software 105 on both servers 102 and client workstations 106 for compressing and decompressing a message for communication over the network 122. Operable software 105 has instructions for encoding and decoding messages according to compression dictionary 104, wherein the compression dictionary 104 maps character segments to character codes. In some embodiments of system 100, the character segments are Extensible Markup Language (XML) tags. In one such embodiment, the character codes are single characters that are mapped to commonly occurring XML tags.

In some embodiments, system 100 further comprises software 101 for the generation of a compression dictionary on one or more of the servers 102 and/or clients 106. In some embodiments, the software 101 for generating a compression dictionary 104 comprises instructions for identifying and extracting character segments of one or more files, wherein the character segments appear one or more times in the one or more files and instructions for creating a compression dictionary 104 based on extracted character segments from the one or more files, wherein the compression dictionary 104 maps the extracted character segments to a character code. In one such embodiment of system 100, the character segments are Extensible Markup Language (XML) tags. In one such embodiment, the character codes are single characters that are mapped to commonly occurring XML tags.

In some embodiments, system 100 may be implemented with servers 102 utilizing one of many available operating systems. Servers 102 may also include, for example, machine variants such as personal computers, handheld personal digital assistants, RISC processor computers, MIP single and multiprocessor class computers, and other personal, workgroup, and enterprise class servers. Further, servers 102 may also be implemented with relational database management systems and application servers. Other servers 102 may be file servers.

Client workstations 102 within embodiments of system 100, may include personal computers, computer terminals, handheld devices, mobile phones, household appliances, and wristwatches. Client workstations 102 include software thereon for performing operations in accordance with received messages. For example, a client workstation 102 may include a web browser for displaying web pages.

The network 122 within an embodiment of a system 100 may include a Local Area Network (LAN), Wide Area Network (WAN), or other similar network 145 within network 122. Network 122 may itself be a LAN, WAN, the Internet, or other large scale regional, national, or global network or a combination of several types of networks. Some embodiments of system 100 include a LAN, WAN, or other similar network 145 that utilizes one or more compression dictionaries 150 on servers 152 and clients 155 behind a firewall 160 within the LAN, WAN, or other similar network 145.

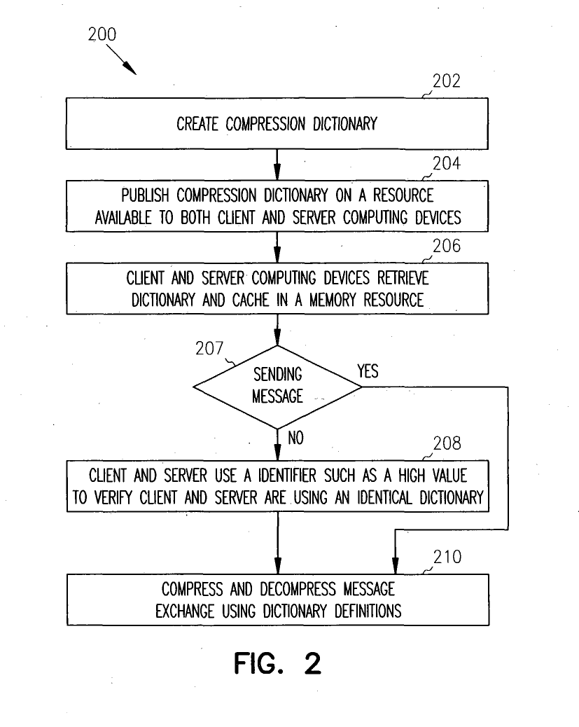

FIG. 2 shows a generalized method of creating and using a compression dictionary generally at 200 according to an embodiment of the present invention. Method 200 comprises creating 202 a compression dictionary 104 and publishing 204 the compression dictionary 104 on a resource available to both clients 106 and servers 102. Clients 106 and servers 102 retrieve 206 the compression dictionary 104 caching the compression dictionary in a memory resource such as volatile or non-volatile memory or a storage resource. Method 200 further comprises determining 207 if a message is being sent or received. If a message is being received, the client 106 or server 102 receiving the message uses an identifier in the message to determine 208 if the compression dictionary 104 used to compress the message is available in cache. If not, the method retrieves 206 the appropriate compression dictionary 104. Once the appropriate compression dictionary 104 is either determined 208 to be present or retrieved 206, the message is decompressed 210 using the compression dictionary 104 definitions. If a message is being sent, method 200 comprises compressing 210 the message according to the compression dictionary 104 definitions.

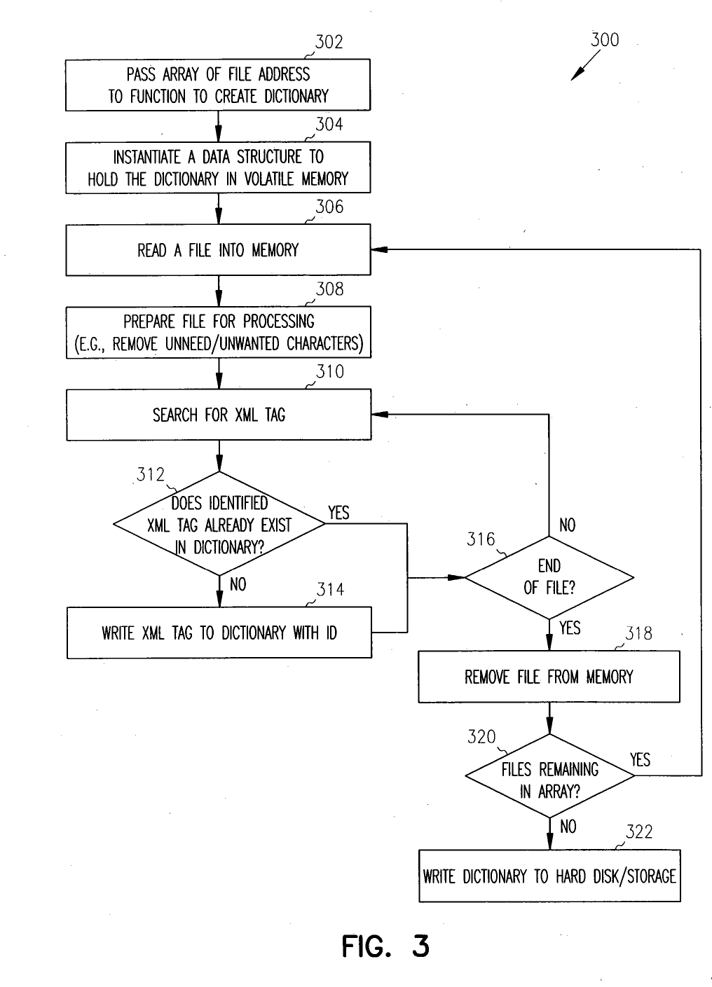

FIG. 3 shows a method 300 according to an embodiment of the invention for the creation 202 of a compression dictionary 104. This embodiment of method 300 comprises passing 302 an array of file address to a function or method to create a dictionary. The file addresses identify a number of data files, such as XML data files to be compressed. In some embodiments, a data structure is instantiated 304, such as a hash table when implementing method 300 in a computer programming language such as Java, to hold the compression dictionary 104 in memory. The file or files included in the array passed 302 to the function or method are read 306 into memory and, in one such embodiment, prepared 308 for processing.

In the present embodiment of method 300, the method further comprises searching 310 for XML tags in the file based on character sequences. When an XML tag is found, method 300 determines 312 if the XML tag has been previously identified. If not, method 300 writes 314 the XML tag to the compression dictionary 104 with a character code. Method 300 proceeds once the XML tag is added to the compression dictionary 104 or if the identified XML tag already existed in the dictionary 104, the method determines 316 if the end of the file has been reached. If not, the method again searches 310 for XML tags and proceeds until the end of the file is reached.

Once the end of the file is reached, the file is removed 318 from memory by performing an operating such as closing the file and determining 320 if there are files remaining to be processed. If there are files remaining to be processed, the next file is read 306 into memory and method 300 proceeds until all files have been processed. Once all of the files have been processed, the compression dictionary 104 is written 322 to a non-volatile memory or storage location so as to preserve the compression dictionary 104.

In further accord with an embodiment of method 300, preparing 308 the files for processing may include in some embodiments, removing white space from a file, removing certain characters, or changing other attributes or properties of the file or its contents. Preparation 308 of the file is performed in some embodiments as a normalizing technique to make a file ready for further processing according to the specific requirements of a specific embodiment of method 300.

Character sequences include sequences such as “<****>” wherein the asterisks indicate any character between the characters “<” and “>” as frequently used in XML. Other character sequences may be relevant in other embodiments of method 300, and other embodiments of method 300 for generating a compression dictionary for a language or purpose other than XML are readily apparent to one skilled in art.

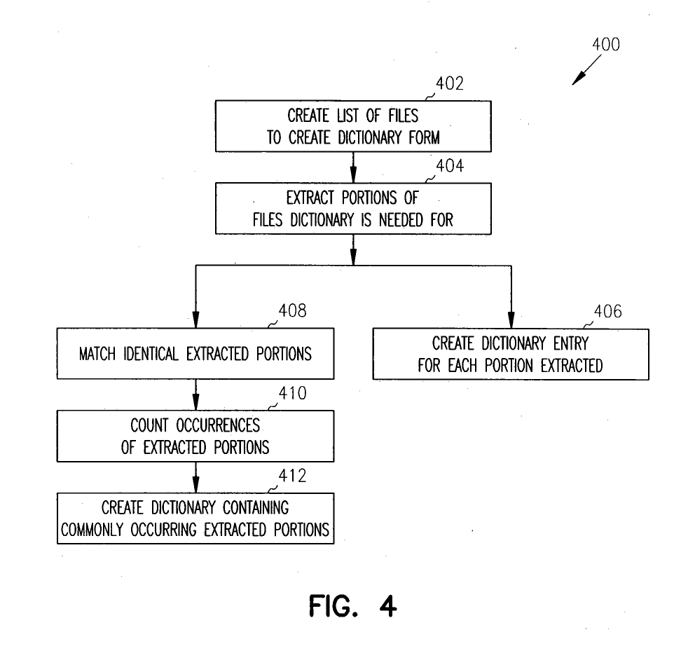

Another embodiment of a method 400 for the creation of a compression dictionary is shown in FIG. 4. Method 400 creates 402 a list of files to create a dictionary 104 from. The list may be selected from commonly requested files, or based on file length or another selection criteria as desired. Files identified in the list are processed by extracting 404 desired portions of the files. For example, XML or HTML tags may be extracted from the files. Method 400 comprises the option of choosing at least whether to create 406 a dictionary 104 entry for each portion extracted 404 from the files or matching 408 identical extracted portions of files and counting 410 the occurrences of each extracted portion. A dictionary entry is then created 412 containing only the most commonly occurring extracted portions of the files.

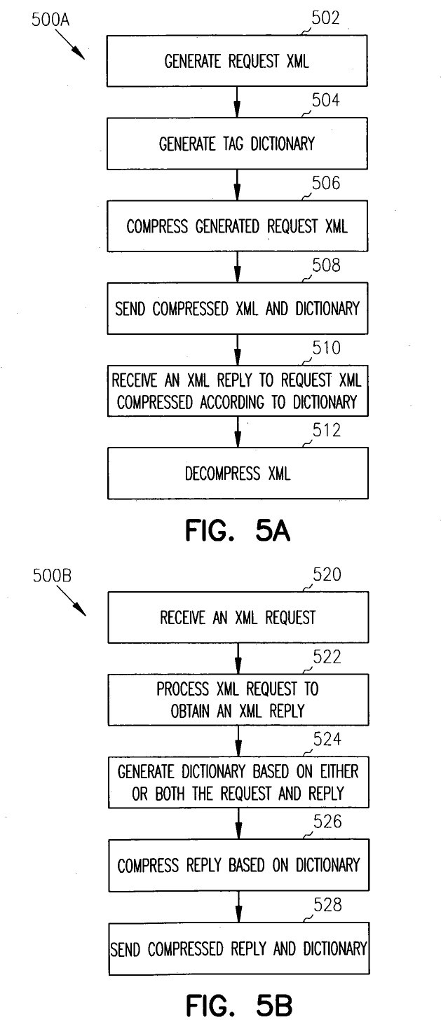

FIGS. 5A, 5B, and 5C show flow diagrams according to three embodiments of the invention. Specifically, FIG. 5A shows an embodiment of a method 500 of creating a compression dictionary 104 on a client 106 dynamically. Method 500 comprises generating 502 an XML request, generating 504 an XML tag compression dictionary 104, compressing 506 the generated 502 XML request according to the generated 504 XML tag dictionary, and sending 508 the compressed 506 generated 502 XML request and generated 504 XML tag compression dictionary to a server 102. The method 500 further comprises receiving 510 a response to the compressed XML request and decompressing 512 the received response. In some embodiments, the request is decompressed to an object model document such as Document Object Model (DOM), bypassing decompression into XML. Some further embodiments, when a compression dictionary already exists, bypass the creation of the XML request and generation of the XML, going straight to compressed requests.

In one embodiment where a request is decompressed directly to DOM, the compression dictionary maps compression entries to DOM elements. Thus, when compressing from DOM, rather than converting DOM elements to XML compression entries, as in some other embodiments, the DOM elements are converted to DOM compression elements that are later decompressed directly to the original DOM elements.

FIG. 5B shows an embodiment of method 500 implemented on a server 102 when an XML request is received that is not compressed. In some embodiments, server 102 receives 520 and processes 522 an XML request to obtain a reply. Server 102 then generates 524 a compression dictionary 104 based on either or both of the received 520 request and obtained 522 reply. The reply is then compressed 526 based on the generated 524 compression dictionary 104 and the reply is sent 528 along with the compression dictionary.

FIG. 5C shows an embodiment of a method 550 for generating a compression dictionary that is available for system-wide use. This embodiment includes generating 560 a compression dictionary 104 for a system, publishing 562 a generated 560 compression dictionary in a location where the dictionary is available to other nodes of the system, obtaining 564 requests for the compression dictionary, and fulfilling 566 the requests. In this embodiment a system includes networked systems available over the Internet, a LAN and/or WAN, wireless network, or other types of systems wherein nodes of the system are logically or physically connected. Some embodiments of method 550 further and/or alternatively include publishing 562 a generated 560 compression dictionary 104 on both server and client nodes within a networked system so as to fully or partially eliminate the need for requesting a compression dictionary.

In some embodiments of a method 550, one or more compression dictionaries 104 are generated 560 from a Web Services Description Language (WSDL) definition for an entire system interface. In such an embodiment, the one or more compression dictionaries 104 are available on one or more network resources to allow for compression of messages sent between nodes on a network using one or more synchronized compression dictionaries.

In some embodiments, processing an XML request comprises querying a database, such as a relational database management system (RDBMS), a file server, or a flat file, resident or stored on the same server 102 or another server connected to the network 122.

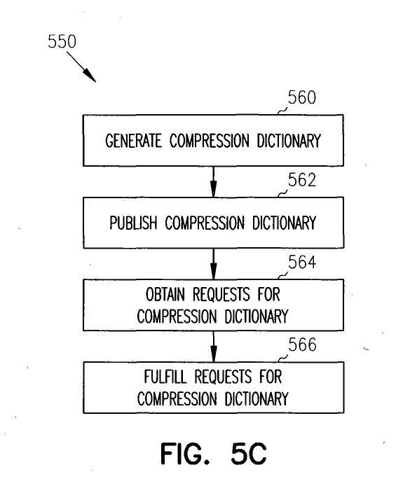

FIG. 6 shows one embodiment of a method 600 for verifying the compression dictionaries 104 on the client 106 and the server 102 match when exchanging compressed messages. The embodiment of method 600 shown in FIG. 6 comprises receiving 602 a compressed XML message and an identifier for the compression dictionary 104 used to compress the message. An identifier is then either retrieved or determined for one or more compression dictionaries cached on the server 102 or client 106 receiving the message and compared 604 against the identifier received 602 with the compressed XML message. If a match is not made, the client or server receiving the message retrieves a copy of the compression dictionary 104 from a location on the network 122. Once the proper compression dictionary is either obtained or matched, the XML request is then decompressed 608.

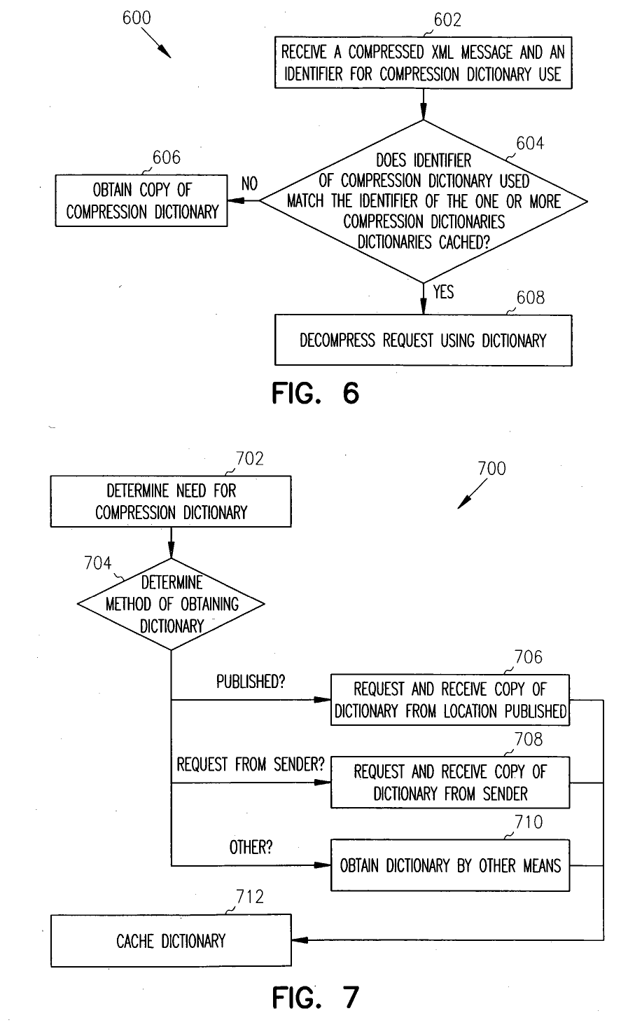

FIG. 7 shows an embodiment of a method 700 for obtaining a compression dictionary 104. In this embodiment, once a need for a compression dictionary 104 is determined 702, method 700 comprises determining 704 the method of obtaining a compression dictionary 104. In some embodiments, the method of obtaining a compression dictionary comprises downloading 706 a copy of the dictionary from a location on the network 122, requesting and receiving 708 a copy of the dictionary from the other party, or as other specific method 700 embodiments require 710. Once the dictionary is received, the dictionary 104 is cached either before or after the compression dictionary 104 is used to decompress and/or compress a message as required.

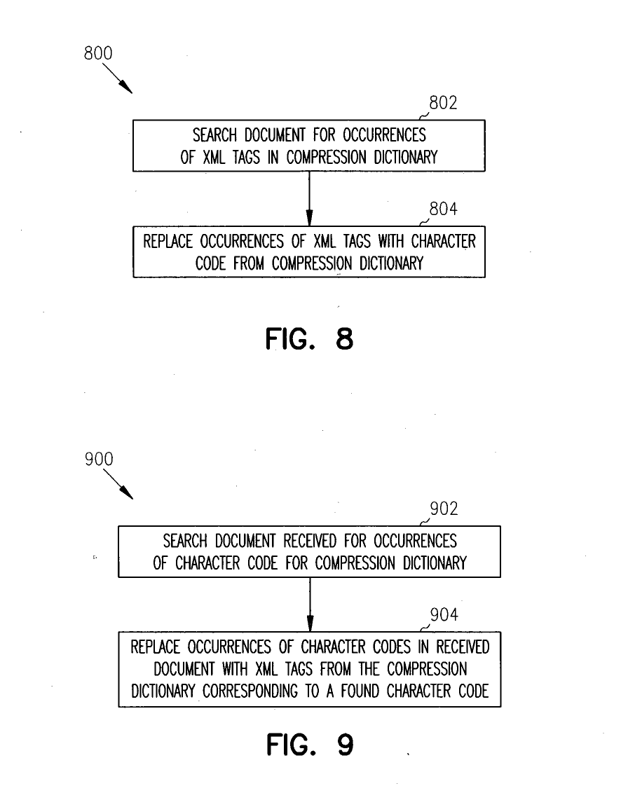

FIG. 8 shows an embodiment of a method 800 for compressing a document. Method 800 searches 802 a document for identified character sequences from a compression dictionary 104 and replacing 804 each occurrence of a character sequence with the character code corresponding to the character sequence in the compression dictionary 104.

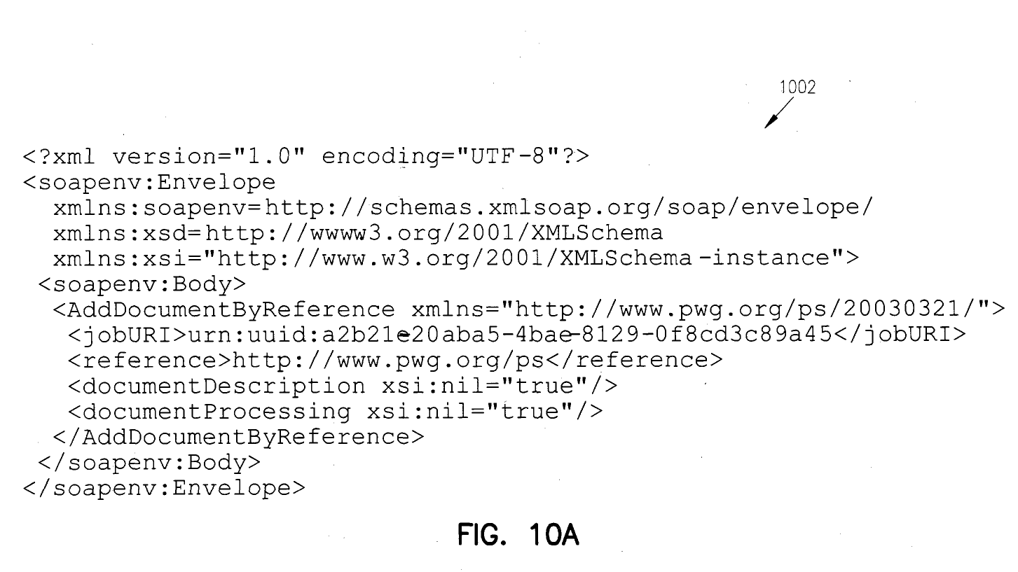

FIG. 9 shows an embodiment of a method 900 for decompressing a document. Method 900 searches 902 a compressed document for occurrences of character codes from the compression dictionary 104 and replaces 1004 those occurrences with the corresponding character sequences.

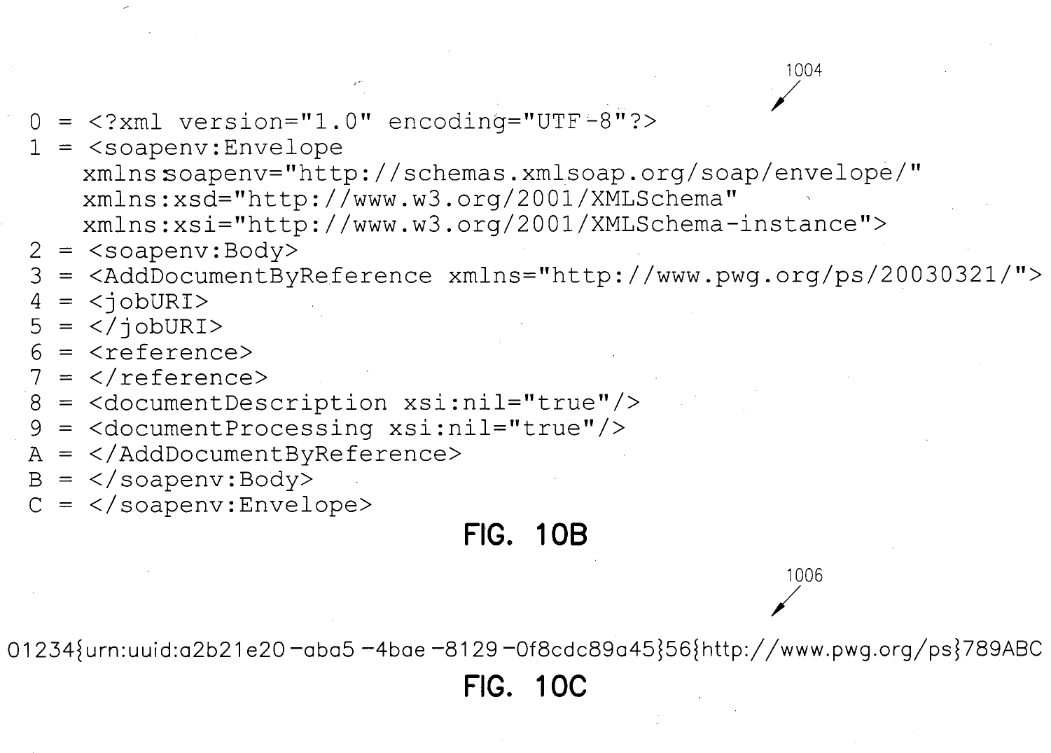

FIG. 10A shows an example Simple Object Access Protocol (SOAP) request message 1002. FIG. 10B shows an embodiment of a compression dictionary 1004 generated for SOAP request message 1002 in FIG. 10A. This embodiment of a compression dictionary 1004 maps each XML tag (on the right of the sign) to a single character code (on the left of the =sign). After removing white space, encoding message 1002 from FIG. 10A using dictionary 1004 from FIG. 10B produces the sequence 1006 shown in FIG. 10C. The portions of message 1002 that could not be compressed are included in the sequence between curly braces ({ }). This compression reduces the original message (minus whitespace) from 529 bytes to 85 bytes (6.22:1 ratio). Further, an embodiment of the above systems and method compresses message 1002 in 1.2 milliseconds. In comparison, on the same computer where the method was implemented, the same message compressed using the GZIP algorithm takes 29.9 milliseconds to achieve a compression ration of 1.78:1. Results may vary significantly for different computers, and this comparison is provided solely as an example, and not a guarantee of similar results.

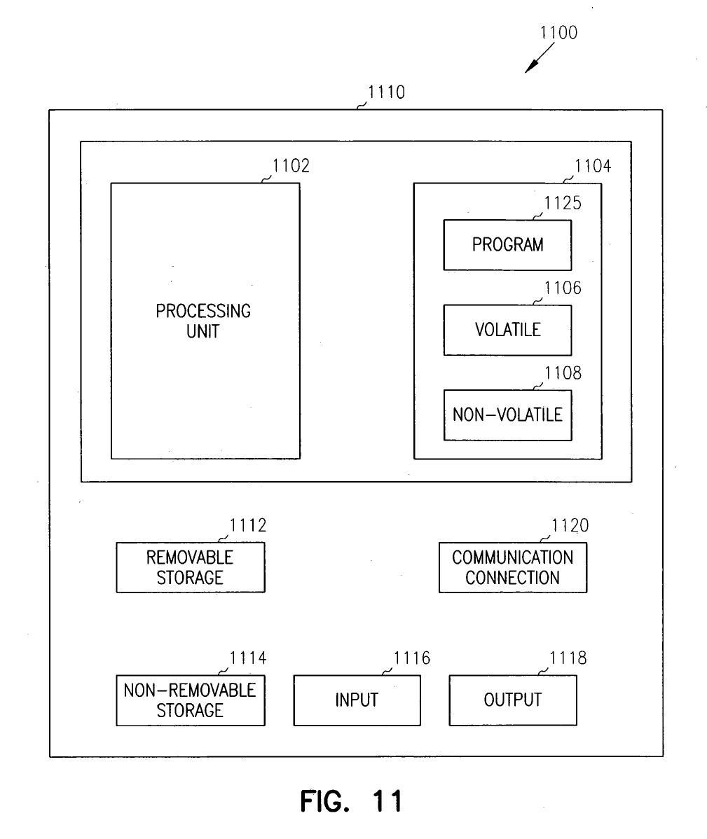

A block diagram of a computer system (i.e. server 102 or client 106) that executes programming for performing the above method is shown in FIG. 11. A general computing device in the form of a computer 1110, may include a processing unit 1102, memory 1104, removable storage 1112, and non-removable storage 1114. Memory 1104 may include volatile memory 1106 and non-volatile memory 1108. Computer 1110 may include—or have access to a computing environment that comprises—a variety of computer-readable media, such as volatile memory 1106 and non-volatile memory 1108, removable storage 1112 and non-removable storage 1114. Computer storage comprises random access memory (RAM), read only memory (ROM), erasable programmable read-only memory (EPROM) & electrically erasable read-only memory (EEPROM), flash memory or other memory technologies, compact disk read-only memory (CD ROM), digital versatile disks (DVD) or other optical disk storage, magnetic cassettes, magnetic tape, magnetic disk storage or other magnetic storage devices, or any other medium capable of storing computer-readable instructions. Computer 1110 may include or have access to a computing environment that comprises input 1116, output 1118, and a communication connection 1120. The computer may operate in a networked environment using a communication connection to connect to one or more remote computers. The remote computer may include a personal computer, server, router, network personal computer (PC), a peer device or other common network node, or the like. The communication connection 1120 may include a Local Area Network (LAN), a Wide Area Network (WAN) or other networks.

Computer-readable instructions stored on a computer-readable medium are executable by the processing unit 1102 of the computer 1110. A hard drive, CD-ROM, and RAM are some examples of articles including a computer-readable medium. For example, a computer program 1125 capable of providing a generic technique to perform access control check for data access and/or for doing an operation on one of the servers in a COM based system according to the teachings of the present invention may be included on a CD-ROM and loaded from the CD-ROM to a hard drive. The computer-readable instructions allow computer system 1100 to provide generic access controls in a computer network system having multiple users and servers, wherein communication between the computers comprises utilizing XML, Simple Object Access Protocol (SOAP), and Web Services Description Language (WSDL).

To achieve the quicker compression results using the compression systems and methods described above, a compression dictionary may be cached at both the client and server ends of a web service conversation. This is possible using web services defined in advance using WSDL (web services definition language). The WSDL definition of a web service can be used to determine commonly invariant XML tags used in SOAP messages passed back and forth between web service clients and servers. Using this information a compression dictionary can be produced, distributed and cached for future re-use by both clients and servers.

Web services commonly publish their WSDL definitions alongside their service endpoints (e.g. http://some.service.com/printme?WSDL). They could also publish compression dictionaries derived from this WSDL.

Thus, a client might send an HTTP get request to http://service.com/printme?WSDICT in order to retrieve a compression dictionary for the printme web service. If the client already had a copy of the compression dictionary (perhaps generated when the client was built or obtained from a different server then it could verify that it was using the right version by adding a hash value to the WSDICT request, thus http://service.com/printme?WSDICT=<dictionary-hash>. The server could then dictionary (i.e. the server also new dictionary or it could dictionary.

1. A method of responding to a request for information, the method comprising:
caching a compression dictionary;
receiving a request for information from a requestor;
compressing the requested information using the compression dictionary; and
sending the compressed information to the requestor with an identifier of the compression dictionary.

2. The method of claim 1 wherein the compressed information may be decompressed directly to an object model document.

3. The method of claim 2 wherein the object model comprises Document Object Model (DOM).

4. The method of claim 1, further comprising:
decompressing a received request for information from a requestor.

5. The method of claim 1, further comprising:
creating a compression dictionary.

6. A computer readable media with instructions thereon for performing the method of claim 1.

7. A method of sending a request for information, the method comprising:
caching a compression dictionary;
sending a request for information to a server;
receiving the requested information, wherein the information received is compressed; and
decompressing the requested information using the compression dictionary.

8. The method of claim 7, further comprising:
compressing the request for information.

9. The method of claim 7, wherein the compressed information may be decompressed directly to an object model document.

10. The method of claim 9, wherein the object model comprises Document Object Model (DOM).

11. The method of claim 7, further comprising:
obtaining a compression dictionary.

12. The method of claim 7, wherein the information received comprises a compression dictionary identifier, the method further comprising:
using the compression dictionary identifier included with the information received to determine if the proper compression dictionary is cached; and
obtaining the proper compression dictionary if the proper compression dictionary is not in cache.

13. The method of claim 12, wherein calculating a compression dictionary identifier may include determining the identifier using a derived hash value for the dictionary.

14. The method of claim 11, wherein the compression dictionary is retrieved from a network location.

15. A communication system comprising:
a network;
two or more network nodes, wherein the network nodes are interconnected via the network;
means for compressing messages; and
means for decompressing messages.

16. The communication system of claim 15, further comprising:
means for creating a compression dictionary.

17. The communication system of claim 15, wherein the two or more network nodes are selected from the group consisting of a computer, a mobile phone, a personal digital assistant (PDA), a handheld navigation device, and a printer.

18. A method of communicating over a network, the method comprising:
creating a compression dictionary;
publishing the compression dictionary on a network resource, wherein the compression dictionary is available upon request across the network;
retrieving the compression dictionary from the network;
caching the compression dictionary; and
compressing and decompressing messages received or sent according to the compression dictionary.

19. The method of claim 18, wherein the compression dictionary comprises compressed representations of Extensible Markup Language (XML) tags.

20. The method of claim 18 wherein the compressing and decompressing messages comprises compressing and decompressing messages directly to and from an object model document.

21. The method of claim 20 wherein the object model comprises Document Object Model (DOM).

22. The method of claim 18, wherein creating a compression dictionary comprises:
creating a list of one or more files;
extracting portions of the files from the list of one or more files;
creating a compression dictionary including portions extracted from the one or more files.

23. The method of claim 18 wherein the network resource comprises a web service interface.

24. A method of creating a compression dictionary, the method comprising:
creating a list of one or more files;
extracting portions of the files from the list of one or more files;
identifying unique portions extracted from the one or more files;
creating a compression dictionary including unique portions extracted from the one or more files.

25. The method of claim 24, wherein the extracting portions of the files comprises extracting Extensible Markup Language (XML) tags.

26. The method of claim 24, further comprising:
counting the occurrences of each unique portion extracted from the one or more files; and
creating a compression dictionary including the most commonly occurring unique extracted portions from the one or more files.

27. A method of decompressing a received compressed message, the method comprising:
receiving a compressed message, wherein the compressed message contains an identifier for a compression dictionary used to compress the message;
comparing the compression dictionary identifier of the received message with an identifier of a cached compression dictionary, wherein if the compression dictionaries match, the compressed message is decompressed, further wherein, if the compression dictionaries do not match, obtaining a copy of the proper compression dictionary.

28. The method of claim 27 wherein the copy of the proper compression dictionary is cached.

29. A communication system comprising:
a server;
a client workstation;
a network, wherein the server and the client workstation are operatively connectable via the network; and
operable software on both the server and client workstation for compressing and decompressing a message for communication over the network, the software including:
instructions for encoding and decoding a message according to a compression dictionary, wherein the compression dictionary maps a character segment to a character code.

30. The communication system of claim 29 wherein the character segment is an Extensible Markup Language (XML) tag.

31. The communication system of claim 29 wherein the character code is a single character.

32. The communication system of claim 29 further comprising:
operable software on at least one of the client and the server for creating a compression dictionary, the software including:
instructions for identifying and extracting character segments of one or more files, wherein the character segments appear one or more times in the one or more files, and
instructions for creating a compression dictionary based on extracted character segments from the one or more files, wherein the compression dictionary maps the extracted character segments to a character code.

33. The communication system of claim 32, wherein the character segments are Extensible Markup Language (XML) tags.

34. The communication system of claim 33, wherein the character code is a single character.

35. A method of responding to a request for information, the method comprising:
creating a compression dictionary tailored for selected information;
receiving a request for at least a portion of the selected information from a requestor;
customizing the information for the requestor;
dynamically compressing the customized requested information using the compression dictionary; and
sending the compressed information to the requestor with an identifier of the compression dictionary.
